(19) United States
(12) Patent Application Publication
(10) Pub. No.: US 2010/0312703 A1
(43) Pub. Date: Dec. 9, 2010

(54) SYSTEM AND METHOD FOR PROVIDING AUTHENTICATION FOR CARD NOT PRESENT TRANSACTIONS USING MOBILE DEVICE

(76) Inventors: Ashish Kulpati, Gurgaon (IN); Pankaj Rajurkar, Indore (IN); Soon Guan Sam Oon, Singapore (SG); Douglas Fisher, Mountain View, CA (US); James Dene Dimmick, Foster City, CA (US); Benedicto Hernandez Dominguez, San Bruno, CA (US); In-Tchang Kim, Singapore (SG)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/791,723

(22) Filed: Jun. 1, 2010

Related U.S. Application Data
(60) Provisional application No. 61/183,631, filed on Jun. 3, 2009.

(51) Int. Cl. G06Q 40/00

(52) U.S. Cl. 705/44

(57) ABSTRACT

A system, apparatus, and method includes infrastructure and processes to enable a consumer to register their mobile phone number and associate that number with a payment account. After registration, the consumer may use their mobile phone to initiate or perform one or more stages of a payment transaction. The payment transaction is recognized as being initiated or performed by a mobile phone, and in response a server may authenticate the transaction based on the mobile phone number and a previous registration and authentication process. In other embodiments, the server may recognize the payment transaction as being initiated or performed by a mobile phone, and in response contact the consumer using the mobile phone to request confirmation of the consumer's desire to perform the transaction.

### CROSS-REFERENCES TO RELATED APPLICATIONS

This application claims priority to U.S. Provisional Patent Application No. 61/183,631, filed on Jun. 3, 2009, the complete disclosure of which is incorporated herein by reference for all purposes.

### BACKGROUND

Consumer payment devices such as debit cards or credit cards are used by millions of people worldwide to facilitate various types of commercial transactions. In a typical transaction involving the purchase of a product or service at a merchant location, the payment device is presented at a point of sale terminal (“POS terminal”) located at a merchant's place of business. The POS terminal may be a card reader or similar device that is capable of accessing data stored on the payment device, where this data may include a consumer's identification data, authentication data, or account data, for example. Some or all of the data read from the payment device is provided to the merchant's transaction or data processing system and then to the acquirer, which is typically a bank or other institution that manages the merchant's account. The data provided to the acquirer may then be provided to a payment processing system or network (e.g., a payment processor) which processes the data to assist in determining if the transaction should be authorized by the network, and assists in the clearance and account settlement functions for the transaction. The authorization decision, clearance, and settlement portions of the transaction may also involve communication and/or data transfer between the payment processing system or network and the bank or institution that issued the payment device to the consumer (the issuer). Transactions in which a consumer payment device is presented to a merchant or accessed by a point of sale terminal are termed “card present” transactions since the payment device is in the same physical location as the merchant or terminal.

In addition to card present transactions, a consumer may also initiate a transaction in a situation in which the payment device is not in the same physical location as the merchant or terminal, and instead the relevant data is provided over a communications network to the merchant (termed a “card not present” transaction). For example, a card not present transaction involving the purchase of a product or service may be initiated by a consumer by providing payment data from a remote location to a merchant over a network such as the Internet. Transactions of this type are typically initiated using a computing device such as a personal computer or laptop computer. Card not present transactions may also be initiated or performed using a mobile payment device such as a mobile phone, in which case communication with a merchant or data processing system may occur over a cellular or wireless network. Thus, payment information for a transaction may be provided using a payment device and point of sale terminal, or may be provided to a merchant using a remotely located payment device, among other methods.

Given the large number of transactions and the amounts of money involved, the detection and prevention of fraud is an important consideration of any transaction processing system. In order to address this problem, payment processors and others involved in authorizing a transaction typically require that a user provide one or more forms of authentication or identification prior to authorizing a transaction. In a card present transaction, a merchant may simply ask for another form of identification from the consumer, such as a picture ID (driver's license, passport, etc.) to provide additional assurance that the person is authorized to use the payment device being presented.

However, in the case of a card not present transaction (such as an eCommerce transaction conducted over the Internet or a transaction that is performed using a mobile payment device) a merchant cannot be as certain that the person who is attempting to use a payment device is the person who is authorized to use that device. The remote nature of the transaction makes a picture ID or other form of identification both impractical and unreliable as a means of authenticating a consumer. Further, requesting an additional piece of supposedly confidential data from the person attempting to use the payment device may not be sufficient to verify that the person is authorized to use the payment device. This is because in some situations the additional data may have been obtained fraudulently in the same manner as the payment device account data was obtained (e.g., by improperly obtaining access to a person's computer that stores the account data and other confidential data). Further, in both payment and non-payment transactions (such as might occur in a trade, contractual negotiation, etc.), each party to a transaction typically prefers to have a means to authenticate the identity of, and the data relating to, the other parties to the agreement or transaction. This is desirable to prevent fraud, misrepresentations, or repudiation of an agreement at a later date. Thus, it is desirable to have reliable methods for the authentication of a party to a transaction in cases where a payment device or party is not present at the location of a merchant or other party to a transaction or agreement. If possible, it is also desirable to utilize elements of existing payment device authentication systems that are used for card present transactions to perform some or all of the authentication operations for card not present transactions, as this will reduce the cost and complexity of the additional authentication processes.

In view of the foregoing, it is desirable to have a system and associated apparatuses and methods for authenticating a consumer that is participating in a remote transaction, such as a card not present transaction conducted over a cellular or wireless network using a mobile payment device. It is further desired that the authentication system be relatively easy to implement and use, and enable consumers to register a mobile payment device for use in a transaction and to be authenticated during a transaction. Further, it would be desirable if the system, apparatuses, and methods did not require a significant investment of new resources to implement, and provided a high level of interoperability between the system's participants. Additionally, it would be desirable if existing authentication systems for web-based e-commerce transactions could be leveraged to permit mobile payment devices to conduct card not present transactions over a mobile channel using some or all of the same system elements. Embodiments of the invention are directed toward solving these and other problems individually and collectively.

### SUMMARY

Embodiments of the present invention are directed to systems and associated apparatuses and methods for authenticating participants engaged in a card not present transaction. In such transactions, one participant to a transaction (and by inference, that participant's payment device) is in a remote location with respect to another participant to the transaction. This may create uncertainty as to the identity of the remotely located participant or as to the authenticity of data provided by the participant. The inventive system, apparatuses, and methods may be used as part of performing payment and non-payment transactions, and are suitable for use in eCommerce transactions conducted using a mobile payment device such as a mobile phone.

One aspect of the present invention is that it may be implemented using elements of the infrastructure that are presently used for authentication of payment devices and participants in card present transactions, and therefore does not require an entirely new set of systems, processes, or operations. Thus, embodiments of the present invention may enable banks and other mobile payment service providers to leverage existing authentication platforms to provide authentication services for card not present transactions initiated using mobile payment devices. This reduces the cost of providing mobile payment services to consumers, and can increase the adoption of such services since consumers and other entities involved in the payment transaction process will already be familiar with many, if not all, of the systems and processes used. Further, embodiments of the present invention may be used by consumers and other entities involved in a payment transaction to provide increased security (including multiple layers of security in authenticating a consumer conducting a transaction), increased transaction processing speed, and greater convenience for consumers than would be possible in the absence of the invention.

In some embodiments, the inventive system, apparatus, and method includes infrastructure and processes to enable a consumer to register their mobile phone number and associate that number with a payment account. After registration, the consumer may use their mobile phone to initiate or perform one or more stages of a payment transaction. The payment transaction is recognized as being initiated or performed by a mobile phone, and in response a server may authenticate the transaction based on the mobile phone number and the previous registration and authentication process. In other embodiments, the server may recognize the payment transaction as being initiated or performed by a mobile phone, and in response contact the consumer using the mobile phone to request confirmation of the consumer's desire to perform the transaction.

In one embodiment, the present invention is directed to an apparatus for authenticating a consumer conducting a payment transaction using a mobile device, where the apparatus includes a processor programmed to execute a set of instructions, a data storage medium coupled to the processor, and the set of instructions contained in the data storage medium, wherein when the set of instructions are executed by the processor, the apparatus authenticates the consumer by registering the mobile device and associating the mobile device with a payment account of the consumer, authenticating the registration of the mobile device using identification data previously supplied by the consumer and associated with the payment account, receiving data initiating the payment transaction, and determining that the payment transaction was initiated using the mobile device.

In another embodiment, the present invention is directed to a method for authenticating a consumer conducting a payment transaction using a mobile device, where the method includes receiving data identifying the mobile device and data identifying a payment account of the consumer, authenticating the mobile device using identification data previously supplied by the consumer and associated with the payment account, receiving data initiating the payment transaction, and determining that the payment transaction was initiated using the mobile device.

In yet another embodiment, the present invention is directed to a method of conducting a payment transaction, where the method includes associating a consumer payment account and first consumer identification data, wherein the first consumer identification data is used by the consumer to approve payment transactions made using the consumer payment account, receiving data identifying a mobile device and data identifying the consumer payment account, requesting the consumer to provide the first consumer identification data, authenticating the mobile device if the response to the request is the first consumer identification data, receiving data initiating the payment transaction, determining that the payment transaction was initiated using the mobile device, and in response to determining that the payment transaction was initiated using the mobile device, authenticating the consumer.

Other objects and advantages of embodiments of the present invention will be apparent to one of ordinary skill in the art upon review of the detailed description of the present invention and the included figures.

### BRIEF DESCRIPTION OF THE DRAWINGS

FIG. 1 is a diagram illustrating the dataflow between various components of an authentication system that may be used during a registration process for a mobile payment device, in accordance with some embodiments of the present invention;

FIG. 2 is a diagram illustrating the dataflow between various components of a transaction approval process that may be used during a payment transaction performed using a mobile payment device, in accordance with some embodiments of the present invention;

FIG. 3 is a diagram illustrating the dataflow between various components of an authentication system that may be used during a registration process for a mobile payment device and mobile device specific authentication data, in accordance with some embodiments of the present invention;

FIG. 4 is a diagram illustrating the dataflow between various components of a transaction approval process that may be used during a payment transaction performed using a mobile payment device and a mobile specific password, in accordance with some embodiments of the present invention;

FIG. 5 is a functional block diagram of the elements of a mobile payment device in the form of a mobile phone that may be used with some embodiments of the present invention; and

FIG. 6 is a functional block diagram of a computing system, apparatus or device that may be used to implement certain of the processes or operations that are part of embodiments of the present invention.

### DETAILED DESCRIPTION

Embodiments of the invention are directed to systems, apparatuses, and methods for enabling the authentication of a transaction or a participant to a transaction in a situation in which the participant is remote from another party to the transaction. An example of such a situation is a card not present (or more accurately, a payment device not present) transaction, such as one conducted using a mobile payment device. The invention includes infrastructure and processes to enable a consumer to register their mobile phone number and associate that number with a payment account. The registration process may be performed using a web-site, and registration may require that the consumer provide authentication data that was previously supplied by the consumer and associated with the payment account. In this way the consumer's mobile phone number becomes associated with the payment account in an authenticated manner. After registration, the consumer may use their mobile phone to initiate or perform one or more stages of a payment transaction. The payment transaction is recognized as being initiated or performed by a mobile phone, and in response a server may authenticate the transaction based on the mobile phone number and the outcome of the previous registration and authentication process. In other embodiments, the server may recognize the payment transaction as being initiated or performed by a mobile phone, and in response contact the consumer using the mobile phone to request confirmation of the consumer's desire to perform the transaction. As examples, this confirmation may take the form of a response to a call to the mobile phone generated by an interactive voice response system (IVR) or by the consumer providing additional authentication data that was previously provided by the consumer and associated with the mobile phone (with the understanding that the additional authentication data could be used by the consumer to authorize transactions performed using the mobile phone).

Many, if not all, of the systems, apparatuses, and methods of the present invention may be implemented using elements of the infrastructure that are presently used for authentication of payment devices and participants in card present transactions. Thus, embodiments of the present invention may enable banks and other mobile payment service providers to leverage existing authentication platforms to provide authentication services for card not present transactions initiated using mobile payment devices. This reduces the cost of providing mobile payment services to consumers, and can increase the adoption of such services since consumers and other entities involved in the payment transaction process will already be familiar with many, if not all, of the systems and processes used. Further, embodiments of the present invention may be used by consumers and other entities involved in a payment transaction to provide increased security (including multiple layers of security in authenticating a consumer conducting a transaction), increased transaction processing speed, and greater convenience for consumers than would be possible in the absence of the invention.

Prior to describing embodiments of the inventive system and methods, certain terms, acronyms and definitions that are used to describe those embodiments will be presented.

As used herein, in some embodiments, an “issuer” can refer to any suitable entity that can open and maintain an account associated with a consumer. Examples of an issuer include a bank, a credit union, a business entity such as a retail store or service provider, or a governmental entity. In many cases, an issuer may provide an electronic commerce card or other form of payment device to a consumer. The issuer typically has an established relationship with the consumer and therefore has data that can be used to authenticate the consumer. Such data may include the consumer's social security number, birthday, account number, shipping address, preferences, etc.

As used herein, in some embodiments, a “server” is typically a powerful computer or cluster of computers. For example, a server may be a large mainframe, a minicomputer cluster, or a group of servers functioning as a unit. In one example, a server may be a database server coupled to a web server. Moreover, a server can behave as a computer which services the requests of one or more client computers or portable electronic devices.

As used herein, in some embodiments, a “merchant server” is a server used to provide an online storefront for consumers, where consumers may shop and conduct online transactions after they decide to purchase goods or services from the merchant.

As used herein, in some embodiments, a “mobile payment service provider” (or “MPI Operator” or “MPI”) performs various authentication functions on behalf of a merchant. The mobile payment service provider may use suitable hardware and/or software that is accessible to a merchant to provide these functions. For example, the MPI may use software running on the merchant server or it may be a component run on a different server accessible by the merchant. The MPI may be able to determine whether authentication is available for a card or payment account number, or validate a digital signature in an authentication message, among other functions. In some embodiments, a mobile payment service provider may use a component that operates in an acquirer domain.

As used herein, in some embodiments, an “access control server” (or “ACS”) provides issuers (or other entities capable of authenticating a consumer conducting an online or card not present transaction) with the ability to authenticate consumers during the transaction. An ACS performs the requested authentication services and provides digitally signed responses to entities requesting authentication. An ACS may be shared by multiple parties. Alternatively, a party may have multiple access control servers, each associated with a different subset of consumers.

As used herein, in some embodiments, a “directory server” can be used to route messages containing enrolment and authentication information between a merchant plug-in or mobile payment service provider and an issuer ACS. The directory server can also determine whether a consumer can utilize the authentication services. In some embodiments, the directory server can be operated by a payment processing or service organization such as Visa.

As used herein, in some embodiments, a “payment processing system” or “payment processing network” may include data processing server computers, subsystems, networks, and operations used to support and deliver authorization services, exception file services, and clearing and settlement services. An exemplary payment processing system or network may include VisaNet. Payment processing systems and networks are able to process credit card transactions, debit card transactions, and other types of commercial transactions. Payment processing systems and networks may also have systems which perform clearing and settlement services. The payment processing system or network may use any suitable wired or wireless network, including the Internet to permit communication and data transfer between components or elements.

As used herein, in some embodiments, “Interactive Voice Response” (or “IVR”) refers to telephony system technology that allows a computer apparatus to detect voice and touch tones via a normal phone call and to enable interaction with a consumer by means of the phone call.

As used herein, in some embodiments, “Short Message Service” (or “SMS”) can be used to refer to a well-known protocol for messages that are sent to and from mobile phones. Typical SMS messages can allow users to send up to 160 characters per message.

As used herein, in some embodiments, a “Mobile Subscriber ISDN Number” (or “MSISDN”) can be used to refer to a mobile subscriber ISDN (integrated services digital network) number, which may be a consumer's mobile telephone number.

As noted above, embodiments of the invention may be especially useful for conducting remote transactions, i.e., where the consumer and payment device are not in the presence of a merchant. Remote transactions can be conducted through communications methods including, but not limited to, mobile or land-line voice calls, Short Message Service (SMS) messages, etc. Various data transfer protocols (e.g.: TCP/IP) may also be used. Remote transactions can be initiated from mobile payment devices including, but not limited to, mobile phones, Smartphone's, Internet-connected computers or terminals, personal digital assistants (PDAs), etc.

In some embodiments, prior to enabling a consumer to utilize their mobile payment device for a payment transaction, the mobile device is registered and associated with a payment account belonging to the consumer. The registration process may include an authentication process wherein the consumer is requested to provide information that confirms their identity or proves that they are authorized to conduct payment transactions using the payment account. Such information may take the form of a passcode, password, security data, or other form of authentication or identification data that was previously provided to an authentication service. In such a case, the consumer information was previously verified and established as a satisfactory way of “proving” that the person submitting the information is the consumer who is authorized to use the payment account. For example, a consumer seeking to register their mobile payment device may be asked to submit their mobile phone number or other form of mobile payment device identifier, and the account number for the payment account that they wish to have associated with the mobile identifier. An authentication service may then request that the consumer submit a form of authentication data to confirm their identity (e.g., a password, etc.), where the authentication data was previously submitted and associated with the consumer. If the authentication data submitted by the consumer is verified as being correct (i.e., it is the data previously submitted and associated with the consumer or the consumer's payment account), then the mobile device identifier is associated with the consumer's payment account. As will be described, in some embodiments of the invention, this may enable the consumer to perform payment transactions using the mobile device without the need to submit any further authentication or identification data.

Thus, in some embodiments of the invention, a consumer can be authenticated (e.g., for purposes of conducting transactions at a later time) while the consumer is in the process of enrolling in a mobile payment service. The consumer can then conduct transactions using the mobile payment service without the need for additional authentication at the time of the transaction. This provides the consumer with a convenient way to use their mobile payment device for payment transactions.

As noted, some aspects of a consumer authentication process can be done during the registration of a mobile payment device as a way of ensuring that only a consumer who has been properly authenticated by the authentication service can enroll in a mobile payment service (and thereby use their mobile payment device to perform payment transactions). As an example, a consumer may enroll in a mobile payment service by registering a mobile phone number and a personal account number (PAN) with a mobile payment service provider. In some embodiments, an ACS may request the consumer to submit a previously accepted password that has been associated with the payment account. In some embodiments, an ACS may choose to authenticate the consumer through a separate channel or request as part of the registration process (e.g., by placing a call to the mobile phone, sending a request for information via a messaging service to a desktop computer, etc.). During a subsequent transaction initiated by the consumer, the mobile payment service provider can validate the phone number and the PAN used by the consumer during the transaction. In some embodiments, during a transaction, the mobile payment service provider may request creation of an authentication signature from an ACS without going through a separate authentication process with the consumer.

Note that in some embodiments, the mobile payment service provider and ACS operator in the issuer domain may enter into a bilateral agreement to ensure that the ACS system can distinguish between a transaction being conducted on a mobile channel and a web-based transaction. As will be described, this may be done to enable the inventive system to recognize that a transaction is being conducted using a mobile payment device, and in response to apply a specific authorization process to that transaction. Note that, if desired, the mobile payment service provider may modify its service enrollment system to ensure that only those users that have been authenticated by a specified authentication system can register for the mobile payment service. In other embodiments, the ACS system may be operative to be able to distinguish and authenticate a mobile transaction without any agreement, participation or change by the mobile payment service provider. Given the large number of eCommerce merchants, the ability to authenticate mobile payment transactions without requiring changes by the merchant may be advantageous. In such embodiments, when the consumer is redirected by the merchant to the ACS, the ACS utilizes the HTTP headers to recognize that the consumer is using a mobile device. The ACS then sends a properly formatted password request window to the consumers device. The consumer enters their pre-registered password, the ACS authenticates the consumer, and provides the results of the authentication back to the mobile payment service provider.

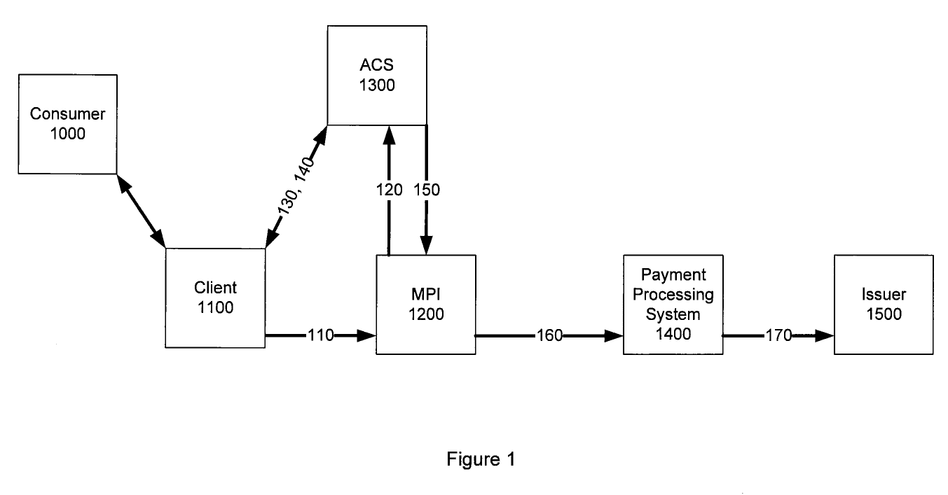

FIG. 1 is a diagram illustrating the dataflow between various components of an authentication system that may be used during a registration process for a mobile payment device, in accordance with some embodiments of the present invention. As shown in FIG. 1, in a typical use case, a user or consumer 1000 uses a client 1100, such as a web browser running on a personal computer, to register a mobile payment device for use with a payment account. The consumer 1000 registers his or her personal account number (PAN) and MSISDN by sending this information to an MPI 1200 via the client 1100. Typically, the MSISDN will be the consumer's mobile phone number in the case of the mobile payment device being a mobile phone; however, if the payment device is not a mobile phone, then the MSISDN may be another form of data. In some embodiments, the consumer 1000 uses a web browser running on the client 1100 to access a website run by the MPI 1200 to submit this information. Note that the client 1100 may not be the mobile communication device that is being registered by the consumer 1000 for use as a mobile payment device, although in some embodiments, the client may be the same device (or resident on the device) that is being registered as a mobile payment device. The submission of this information is shown as data flow 110 in FIG. 1.

Next, the MPI 1200, determines the proper ACS 1300 for the specific payment account submitted by the consumer 1000. In some embodiments, the MPI 1200 accesses a directory server to look up the proper ACS 1300. Once the MPI 1200 has located the proper ACS 1300, the MPI 1200 sends the PAN with MSISDN submitted by the consumer 1000 to the ACS 1300. The transmission of the PAN and MSISDN is shown as data flow 120 in FIG. 1.

The ACS 1300 may then interact with the client 1100 used by the consumer 1000 to perform or complete the registration process. Note that in some embodiments, the registration process may include a portion, or all, of an authentication process. In some embodiments, the registration may include the ACS 1300 sending a web page to the client 1100 over the internet. The transmission of a web page is shown as data flow 130. The consumer 1000 can then enter a password or other security data into the web page and submit this information back to the ACS 1300. The password or other security data submitted by the consumer may be a password or data that has previously been established by the consumer 1000 to authenticate card not present transactions, such as transactions conducted on e-commerce sites over the internet (although this is not required, as the password or data may have been established by the consumer to authenticate other types of payment transactions). Thus, in some embodiments, a consumer may register their payment account information and provide a password to be used for authenticating the consumer in certain transaction situations. When the consumer later seeks to register their mobile phone number and PAN in order to use their mobile phone for mobile payment transactions, they may be asked to provide the previously submitted password to authenticate themselves. The consumer's response may also serve to confirm their desire to have the mobile phone number associated with the PAN for purposes of using their mobile phone for payment transactions. Note that in some embodiments, the password provided to ACS 1300 may be a new password that is being registered by the consumer for use with card not present, or more specifically, mobile transactions. The submission of the password to the ACS 1300 is shown as data flow 140.

If the submitted password is one that was previously established by the consumer, then the ACS 1300 can verify the password and send the authentication result (i.e., that the consumer is properly authenticated) to the MPI 1200. The ACS 1300 can also send other information with the authentication result, such as a cardholder authentication verification value (CAVV). This communication is shown as data flow 150. A previously established password can be one such as that described in U.S. Pat. No. 7,007,840, which describes a process for enabling a consumer to register a PAN corresponding to a consumer payment account and have that account associated with a password which the consumer may use at a later time to authenticate themselves. If the submitted password is a new one that is being registered by the consumer, then the ACS 1300 may request other data from the consumer before providing an indication to MPI 1200 that the consumer is authenticated. Such other data may include consumer profile or identification data, for example.

After receipt of a confirmation that the consumer is authenticated, the MPI 1200 may send an authentication message to the issuer 1500 to validate a submitted card verification value (CVV2), and confirm that the payment account that the consumer seeks to use for a mobile payment device transaction is active. The MPI 1200 may submit this authentication message to the issuer 1500 using a payment processing system 1400. This data flow is shown as 160 and 170. Once the payment account (e.g., a credit or debit card) is verified, then the mobile payment device is registered for use by the consumer 1000 in card not present transactions.

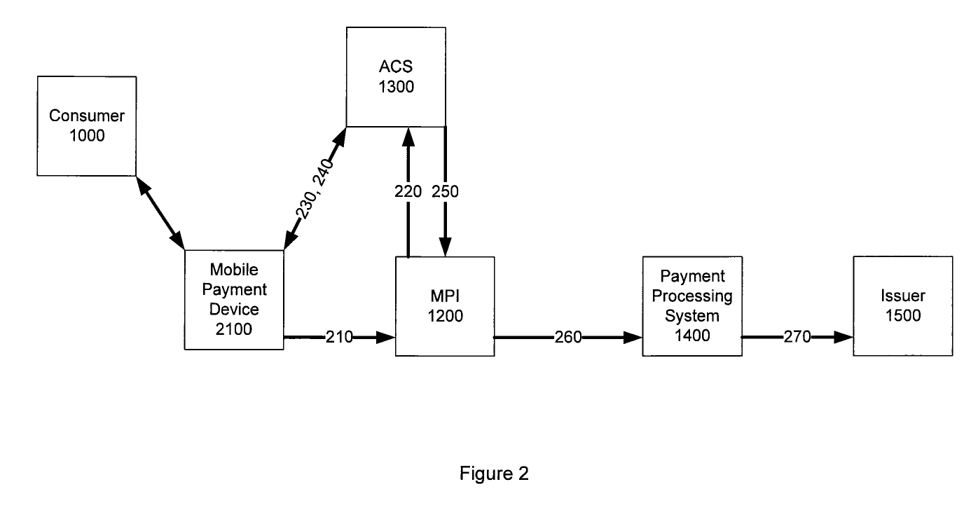

FIG. 2 is a diagram illustrating the dataflow between various components of a transaction approval process that may be used during a payment transaction performed using a mobile payment device, in accordance with some embodiments of the present invention. As shown in the figure, in a typical payment transaction, a consumer 1000 initiates a card not present transaction using the consumer's 1000 registered mobile payment device 2100 (where the registration process is conducted in accordance with the process depicted in FIG. 1, or another suitable process). In some embodiments, the consumer 1000 may initiate the transaction by entering a client PIN (personal identification number) into the mobile payment device 2100, by activating a payment application installed on the mobile device 2100, by providing another form of access control or security data to the device, or by engaging in another form of user interaction with the device. In response, the mobile payment device 2100 then initiates the payment transaction with a mobile payment operator host 1200. This stage is shown as data flow 210. The data communicated in data flow 210 may include the MSISDN of the mobile payment device, although it may include other data as well in addition to, or instead of the MSISDN.

Based on the MSISDN and/or other data received from the mobile payment device 2100, the MPI 1200 is able to determine the consumer payment account associated with the consumer. The MPI 1200 of the mobile payment provider may then request authentication from the ACS 1300 associated with the payment account of the registered mobile payment device 2100 (or more precisely, confirmation of the previous authentication of the consumer and/or mobile payment device). In some embodiments, the MPI 1200 may use a directory server to lookup the proper ACS 1300 for the payment account of the consumer 1000. Once the MPI 1200 has determined the proper ACS 1300 for authentication, the MPI 1200 may send an authentication request to the ACS 1300. This request by the MPI 1200 to the ACS 1300 is shown as data flow 220.

The ACS 1300 recognizes the request from the MPI 1200 as being associated with a mobile payment transaction initiated using a specific mobile payment device and, based on the data provided as part of the previous registration and authentication process (as described with reference to FIG. 1), can create an authentication or transaction approval message for the payment transaction. According to some embodiments, the ACS 1300 may optionally cause an IVR call to be generated to the mobile payment device 2100 to confirm the intent of the consumer 1000 to conduct the transaction. An optional IVR call is shown as data flow 230 and 240, where one element of the data flow is an IVR generated call to the mobile device, and the other element of the data flow is a response to the IVR call generated by the consumer using the mobile device. After performing any additional authentication or verification operations that may be utilized (or without performing any such operations if none are required), the ACS 1300 sends an authentication result to the MPI 1200, where this is shown as data flow 250. The authentication result may contain other relevant authentication data, such as a CAVV. Note that in addition to use of an IVR system, other forms of confirming the intent of the consumer to conduct the transaction may also be utilized; these include, but are not limited to, an exchange of SMS messages, email messages, the consumer providing a specific numeric or alphanumeric code in response to a message, etc. Note further, that the use of an IVR call or other form of confirming a consumer's intent to conduct a transaction may be selectively applied to only certain transactions, such as those that are suspected of being fraudulent, those having a value that exceeds a predetermined threshold amount, or any other suitable criteria.

The MPI 1200 uses the authentication result received from the ACS 1300 (which, as noted may include data such as the CAVV and/or other payment device or payment account related data) to provide an authorization for the payment transaction to the issuer 1500 for the payment account being used by the consumer. This authorization may be communicated via a payment processing system 1400, where the process is shown as data flows 260 and 270. The authorization communicated to the issuer may include information that identifies the transaction as a card not present transaction being conducted using an authorized mobile payment device.

Note that in the example payment transaction process described with reference to FIG. 2, no additional consumer authentication is required to be performed by ACS 1300 during the transaction (although as noted, an IVR authentication or other form of supplemental authentication may be utilized). Instead, the ACS 1300 recognizes the transaction received from the MPI 1200 as a card not present transaction that has been initiated using a previously authenticated mobile payment device 2100. This enables a consumer to conduct a payment transaction with a mobile payment device without having to provide additional authentication information, thereby reducing the inconvenience to the consumer and expediting the transaction.

In an alternative to the embodiment of the invention described with reference to FIGS. 1 and 2, in some embodiments, during the registration process, a consumer may provide a password or other form of authentication data that is to be used specifically for authorizing a payment transaction initiated using a mobile payment device, or a certain mobile payment device. In such an embodiment, a consumer registers their mobile payment device in a manner similar to that described with reference to FIG. 1; however, during the registration process, the consumer provides an authentication server with a password or other form of authentication data that is registered and associated with transactions that are performed using the consumer's mobile payment device. During a subsequent payment transaction that is initiated using the mobile payment device, the consumer is requested to provide the registered authentication data that has been associated with the device as a form of authenticating the consumer and approving the transaction.

Thus, in this alternative embodiment, a consumer may be asked to provide a new, numeric password (or other suitable form of data, such as an alphanumeric password or character string) for use with the consumer's mobile payment device when the consumer registers their mobile payment device for use in payment transactions. After enrollment with a mobile payment service, the consumer may perform a payment transaction using their mobile device, where the transaction is authenticated using the numeric password or other data. The new password may be (and in some cases, it may be desirable to be) different from other passwords that may be used to authenticate the user for other types of transactions, such as e-commerce transactions conducted over the internet. Thus, the alternative embodiment allows a consumer to create and register a mobile payment device dedicated password with an ACS. The consumer enters the dedicated password into a mobile payment device, such as a mobile phone, when conducting a transaction using the mobile payment device. The password can then be routed from the mobile device, through a mobile payment operator, to an ACS for authentication of the consumer and approval of the transaction.

Note that in some implementations, embodiments of the inventive process may require that changes be made within the mobile payment service provider domain (which may be part of the merchant domain) and/or to the ACS (which may be part of the issuer domain) to an authentication system that is configured to authenticate standard e-commerce transactions (i.e., those not performed using a mobile payment device). Implementation of embodiments of the invention may also result in the reconfiguration of a merchant plug-in in the merchant domain and/or modifications in the issuer domain (i.e., to the ACS) to accommodate a mobile payment device based authentication process. Further, in some cases, the mobile payment service provider may need to implement modifications to its host and mobile phone client software to support the input of a mobile password by a consumer for each transaction and route the password to the ACS operator.

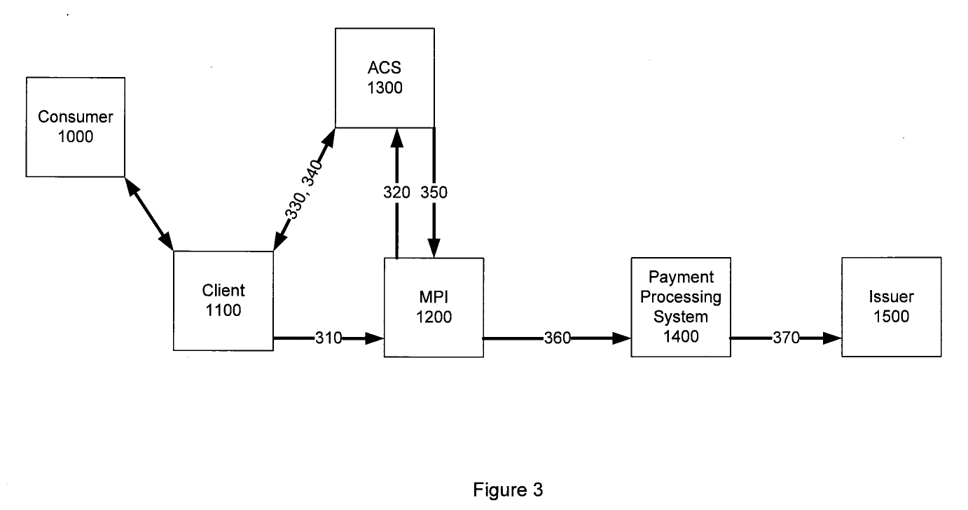

The alternative embodiment of the present invention, in which a mobile payment device specific password or authentication data is used for payment transactions initiated using a mobile payment device, will be further described with reference to FIG. 3. FIG. 3 is a diagram illustrating the dataflow between various components of an authentication system that may be used during a registration process for a mobile payment device and mobile device specific authentication data, in accordance with some embodiments of the present invention.

As shown in the figure, a consumer 1000 uses a client 1100, such as a web browser running on a personal computer, to register a mobile payment device for use with a payment account. The consumer 1000 registers his or her personal account number (PAN) and MSISDN by sending this information to an MPI 1200 via the client 1100. Typically, the MSISDN will be the consumer's mobile phone number in the case of the mobile payment device being a mobile phone; however, if the payment device is not a mobile phone, then the MSISDN may be another form of data. In some embodiments, the consumer 1000 uses a web browser running on the client 1100 to access a website run by the MPI 1200 to submit this information. Note that the client 1100 may not be the mobile communication device that is being registered by the consumer 1000 for use as a mobile payment device, although in some embodiments, the client may be the same device (or resident on the device) that is being registered as a mobile payment device. The submission of this information is shown as data flow 310 in FIG. 3.

Next, the MPI 1200, determines the proper ACS 1300 for the payment account corresponding to the data submitted by the consumer 1000. According to one embodiment, the MPI 1200 accesses a directory server to lookup the proper ACS 1300. Once the MPI 1200 has located the proper ACS 1300, the MPI 1200 can send the PAN with MSISDN submitted by the consumer 1000 to the ACS 1300. The transmission of the PAN and MSISDN is shown as data flow 320 in FIG. 3.

The ACS 1300 can then interact with the client 1100 used by the consumer 1000 to register a mobile payment device specific or mobile transaction specific password or other form of authentication data. According to one embodiment, this process is started when the ACS 1300 sends a web page to the client 1100 over the Internet. The transmission of a web page is shown as data flow 330. The consumer 1000 can then enter his or her “standard” password into the website as well as the new mobile payment device or mobile transaction specific password, and submit this information back to the ACS 1300. The standard password entered by the consumer may be a password that has previously been established by the consumer 1000 to authenticate card not present transactions, such as transactions conducted on e-commerce sites over the internet (although this is not required, as the password or data may have been established by the consumer to authenticate other types of payment transactions). The standard password may be established by any suitable process or operation, such as that described with reference to FIG. 1, or as described in the previously referenced U.S. Pat. No. 7,007,840, entitled “Managing Activation of Cardholders in a Secure Authentication Program”, the contents of which has been incorporated by reference it its entirety for all purposes. The mobile payment device or mobile transaction specific password may be a numeric, alphanumeric, or other form of password or authentication data that will be associated with a registered mobile payment device and used as part of an authentication process for card not present transactions conducted using the device. The submission of these passwords to the ACS 1300 is shown as data flow 340. Note that the standard password and the mobile specific password may be submitted as part of the same data submission or as separate data submissions, for example, using two separate web-page based forms (where the submission of the mobile specific password may be in response to a request or form generated in response to submission of the standard password).

The ACS 1300 receives the submitted data and can then verify the standard password, establish the mobile specific password for the mobile payment device, and send the authentication result to the MPI 1200. The ACS 1300 can also send other information with the authentication result, such as a cardholder authentication verification value (CAVV). This communication is shown as data flow 350.

The MPI 1200 can then send an authentication message to the issuer 1500 to validate a submitted card verification value (CVV2) and to confirm whether the consumer's account is active. The MPI 1200 may submit this authentication message to the issuer 1500 using a payment processing system 1400. This data flow is shown as elements 360 and 370 in the figure. Once the card is verified, the mobile payment device is registered for use by the consumer 1000 in card not present transactions.

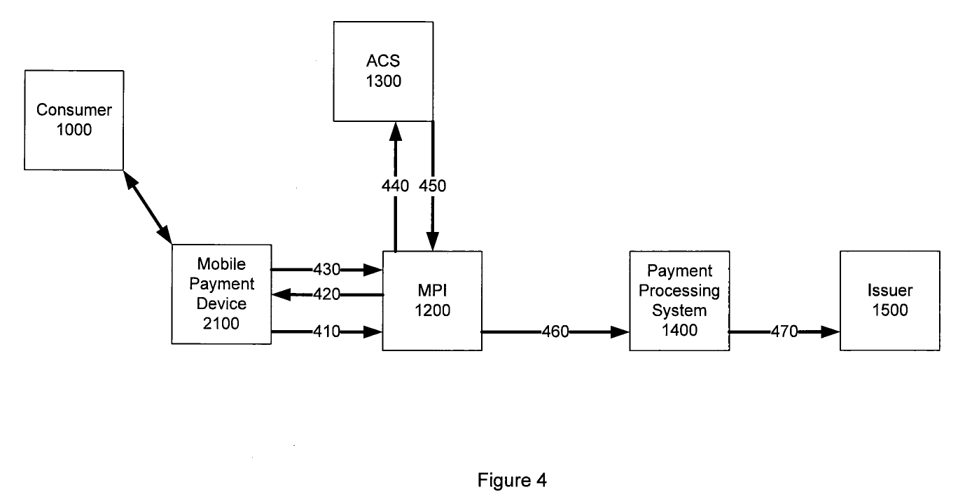

FIG. 4 is a diagram illustrating the dataflow between various components of a transaction approval process that may be used during a payment transaction performed using a mobile payment device and a mobile specific password, in accordance with some embodiments of the present invention. In a typical payment transaction, a consumer 1000 initiates a card not present transaction using the consumer's registered mobile payment device 2100. In some embodiments, the consumer 1000 may initiate the transaction by entering a client PIN (personal identification number) into the mobile payment device 2100, by activating a payment application installed on the mobile device 2100, by providing another form of access control or security data to the device, or by engaging in another form of user interaction with the device. In response, the mobile payment device 2100 initiates the payment transaction with a mobile payment services operator 1200. This stage is shown as data flow 410. The data communicated in data flow 410 may include the MSISDN of the mobile payment device, although it may include other data as well in addition to, or instead of the MSISDN.

Based on the MSISDN and/or other data received from the mobile payment device 2100, the MPI 1200 is able to determine the consumer payment account associated with the consumer. The MPI 1200 then requests that the consumer 1000 enter or otherwise provide the mobile payment device or mobile transaction specific password established during the registration process. In response, the consumer 1000 enters his or her mobile specific password into the mobile payment device 2100 and sends this password back to the MPI 1200. This data flow between the mobile payment device 2100 and the MPI 1200 is show as data flows 420 and 430 in the figure.

The MPI 1200 then sends an authentication request to the ACS 1300. In some embodiments, the MPI 1200 may use a directory server to lookup the proper ACS 1300 for the payment account of the consumer 1000. Once the MPI 1200 has located the proper ACS 1300, the MPI 1200 can send the authentication request to the ACS 1300. The authentication request includes the mobile specific password entered by the consumer 1000. This authentication request is shown as data flow 440.

In some embodiments, the ACS 1300 recognizes that the authentication request made by the MPI 1200 is for a card not present mobile payment transaction, and the ACS 1300 supports a separate authentication process that uses the mobile specific password for the mobile payment device 2100 to authenticate the consumer (rather than the standard password, or another password for the payment account). The ACS 1300 authenticates the request based on submission of the correct mobile specific password and sends the authentication result to the MPI 1200. In some embodiments, the authentication result may include other relevant authentication data, such as a CAVV. The transmission of the authentication result to the MPI 1200 is shown as data flow 450.

According to some embodiments, the ACS 1300 may optionally cause an IVR call to be generated to the mobile payment device 2100 to confirm the intent of the consumer 1000 to conduct the transaction. An optional IVR call may include an IVR generated call to the mobile device, and a response to the IVR call generated by the consumer using the mobile device. Note that in addition to use of an IVR system, other forms of confirming the intent of the consumer to conduct the transaction may also be utilized; these include, but are not limited to, an exchange of SMS messages, email messages, the consumer providing a specific numeric or alphanumeric code in response to a message, etc. Note further, that the use of an IVR call or other form of confirming a consumer's intent to conduct a transaction may be selectively applied to only certain transactions, such as those that are suspected of being fraudulent, those having a value that exceeds a predetermined threshold amount, or any other suitable criteria.

The MPI 1200 then uses the authentication response received from the ACS 1300 to authorize the card not present transaction with the issuer 1500 of the payment account used by the consumer 1000. The MPI 1200 may make this request using a payment processing system. This is shown as data flows 460 and 470 in the figure. As illustrated in FIG. 4, the mobile specific password is routed from the consumer 1000 to the ACS 1300 through MPI 1200.

The methods, processes or operations described with reference to FIGS. 1-4 may be practiced using any suitable form of mobile payment device or portable consumer device, including, but not limited to a mobile phone, PDA, portable computer, or other device having a wireless communications and data transfer capability. The mobile payment device or portable consumer device may include a contactless element such as a semiconductor chip, embedded in or otherwise coupled to the mobile phone, PDA, etc. As described, in some embodiments, a consumer may use a mobile payment device or portable consumer device, such as a mobile phone, to conduct payment transactions by providing payment data and by acting as an interface for providing authentication data. Note that embodiments of the invention are not limited to any specific type of mobile payment device or portable consumer device.

An exemplary portable consumer device or mobile payment device may be in one of many suitable forms. For example, suitable portable mobile payment devices can be hand-held and compact so that they can fit into a consumer's pocket (e.g., pocket-sized). They may include smart chips embedded in another device. Examples of portable consumer devices that may function as payment devices include cellular phones, personal digital assistants (PDAs), pagers, transponders, and the like. The portable consumer devices can function as debit devices (e.g., a debit card), credit devices (e.g., a credit card), or stored value devices (e.g., a stored value card).

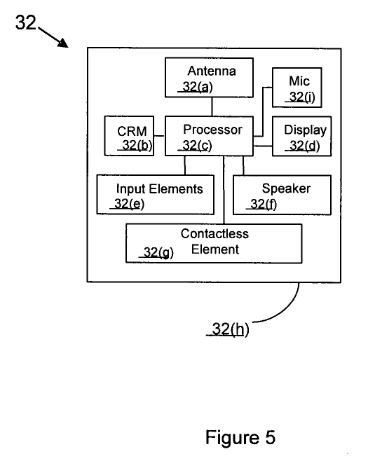

An exemplary mobile payment device may comprise a computer readable medium and a body as shown in FIG. 5, which is a functional block diagram of the elements of a mobile payment device in the form of a mobile phone that may be used with some embodiments of the present invention. Note that FIG. 5 shows a number of components, and the portable consumer devices or mobile payment devices used as part of implementing the invention may comprise any suitable combination or subset of such components. A computer readable medium (CRM) 32(b) may be present within the body 32(h), or may be detachable from it. Body 32(h) may be in the form of a plastic substrate, housing, or other suitable structure. Computer readable medium 32(b) may be a memory that stores data and may be in any suitable form including a magnetic stripe or a memory chip, and may contain uniquely derived keys, encryption algorithms, etc. The memory may also store information such as financial information, transit information (e.g., as in a subway or train pass), access information (e.g., as in access badges), etc. Financial information may include information such as bank account information, bank identification number (BIN), credit or debit card number information, account balance information, expiration date, consumer information such as name, date of birth, etc.

Information in the memory may also be in the form of data tracks, such as those traditionally associated with credit cards. Such tracks may include Track 1 and Track 2. Track 1 typically stores more information than Track 2, and contains the cardholder's name as well as account number and other discretionary data. This track is sometimes used by the airlines when securing reservations with a credit card. Track 2 is currently most commonly used for payment transactions. This is the track that is read by ATMs and credit card terminals. The track typically contains the cardholder's account, encrypted PIN, plus other discretionary data.

The computer readable medium 32(b), or memory, may comprise code which when executed by a programmed processor causes the implementation of the relevant steps, processes, or operations of the present invention. For example, the computer readable medium 32(b) may comprise code that when executed assists in registering a mobile payment device and in using the mobile payment device in a CNP transaction.

The phone 32 may further include a contactless element 32(g), which may include a semiconductor chip (or other data storage element), and in some embodiments an associated wireless data transfer (e.g., data transmission) element, such as an antenna or transducer. Note that the wireless data transfer element is not required in all embodiments of the invention as the contactless element may be integrated with the communications capabilities of the mobile phone, thereby permitting data transfer between the contactless element and a cellular communications network. In such situations, contactless element 32(g) may be embedded within phone 32 and data or control instructions transmitted via a cellular network may be applied to contactless element 32(g) by means of a contactless element interface (not shown). The contactless element interface functions to permit the exchange of data and/or control instructions between the mobile device circuitry (and hence the cellular network) and contactless element 32(g).

In some embodiments, contactless element 32(g) is capable of transferring and receiving data using a near field communications (“NFC”) capability (or near field communications medium) typically in accordance with a standardized protocol or data transfer mechanism (e.g., ISO 14443/NFC). Other suitable short range communications capabilities that may be used to implement the invention include RFID, Bluetooth™ infra-red, or other data transfer capabilities that may be used to exchange data between the phone 32 and a device reader or point of sale terminal. Thus, phone 32 may be capable of communicating and transferring data and/or control instructions via both a cellular network and using a near field or short range communications capability.

Phone 32 will also typically include a processor 32(c) (e.g., a microprocessor or CPU) programmed with a set of instructions, where the processor executes the instructions to implement the various functions of phone 32, and a display 32(d) to allow a consumer to see phone numbers and other information and messages. Phone 32 may further include input elements (such as a keypad, touch screen, etc.) 32(e) to allow a consumer (or presenter) to input information into the device, a speaker 32(f) to allow the consumer to hear voice communication, music, etc., and a microphone 32(i) to allow the consumer to input their voice into the phone 32. Phone 32 will also typically include an antenna 32(a) to enable wireless communications and data transfer (e.g., data transmission) using a cellular communications network.

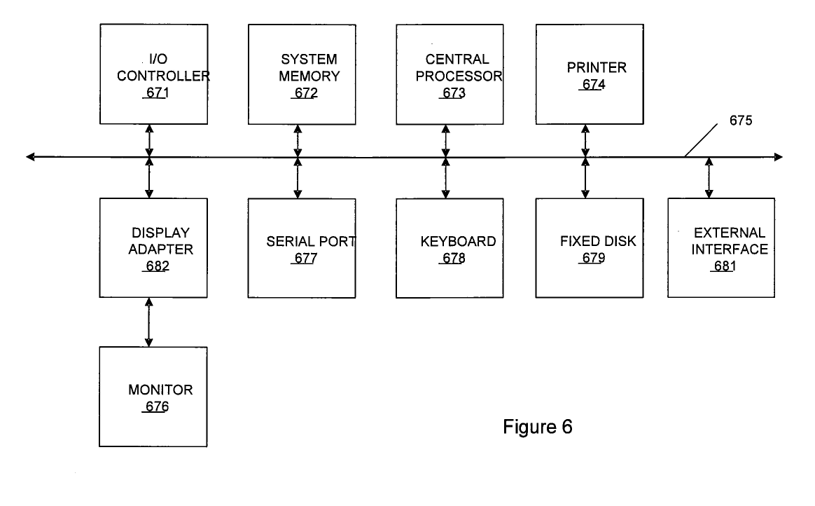

FIG. 6 is a functional block diagram of a computing system, apparatus or device that may be used to implement certain of the processes or operations that are part of embodiments of the present invention. In an exemplary embodiment, some or all of the functional components depicted in FIG. 6 may be present in a server or other form of computing device that performs some or all of the functions of the MPI (element 1200 of FIGS. 1-4), ACS (element 1300 of FIGS. 1-4), or payment processing system (element 1400 of FIGS. 1-4) that are described with reference to embodiments of the present invention. The subsystems shown in FIG. 6 are interconnected via a system bus 675. Additional subsystems such as a printer 674, keyboard 678, fixed disk 679 (or other memory comprising computer readable media), monitor 676, which is coupled to display adapter 682, and others are shown. Peripherals and input/output (I/O) devices, which couple to I/O controller 671, can be connected to the computer system by any number of means known in the art, such as serial port 677. For example, serial port 677 or external interface 681 can be used to connect the computing apparatus to a wide area network such as the Internet, a mouse input device, or a scanner. The interconnection via system bus allows the central processor 673 to communicate with each subsystem and to control the execution of instructions from system memory 672 or the fixed disk 679, as well as the exchange of information between subsystems. The system memory 672 and/or the fixed disk 679 may embody a computer readable medium. As mentioned, some or all of these elements may be present in the previously described devices or apparatuses. For example, the previously described directory server or access control server may include one or more of the components shown in FIG. 6.

A computer readable medium according to an embodiment of the invention may comprise code or another form of executable instructions for performing any of the functions, processes, or operations described with reference to embodiments of the present invention. For example, the previously described MPI may be a computing device that includes a processor and comprises a computer readable medium comprising code that, when executed by a programmed processor, acts to authenticate a consumer to conduct transactions on a mobile device when registering the mobile device for use in transactions, and code for conducting a transaction using the mobile device. Thus, the MPI may include a processor coupled to the computer readable medium, where the processor executes instructions embodied by computer code in or on the computer readable medium.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. Moreover, any one or more features of any embodiment of the invention may be combined with any one or more other features of any other embodiment of the invention, without departing from the scope of the invention.

Also, it should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

A recitation of “a”, “an” or “the” is intended to mean “one or more” unless specifically indicated to the contrary.

What is claimed is:

1. An apparatus for authenticating a consumer conducting a payment transaction using a mobile device, comprising:
a processor programmed to execute a set of instructions;
a data storage medium coupled to the processor; and
the set of instructions contained in the data storage medium, wherein when the set of instructions are executed by the processor, the apparatus authenticates the consumer by
registering the mobile device and associating the mobile device with a payment account of the consumer;
authenticating the registration of the mobile device using identification data previously supplied by the consumer and associated with the payment account;
receiving data initiating the payment transaction; and
determining that the payment transaction was initiated using the mobile device.

2. The apparatus of claim 1, wherein registering the mobile device and associating the mobile device with a payment account of the consumer further comprises receiving registration data from the consumer, the registration data including an identifier of the payment account and an identifier of the mobile device, wherein the registration data is provided by the consumer using a client device.

3. The apparatus of claim 2, wherein the mobile device is a mobile phone and the identifier of the mobile device is the phone number of the mobile phone.

4. The apparatus of claim 2, wherein the registration data is provided by the consumer by entering the registration data into a website using the client device.

5. The apparatus of claim 1, wherein authenticating the registration of the mobile device using identification data previously supplied by the consumer and associated with the payment account further comprises:
requesting the consumer to provide the identification data;
receiving the requested identification data;
verifying the received identification data; and
in response to verifying the identification data, authenticating the registration of the mobile device.

6. The apparatus of claim 5, wherein the identification data is a password previously associated with the payment account and used by the consumer to approve a payment transaction.

7. The apparatus of claim 1, wherein after determining that the payment transaction was initiated using the mobile device, the apparatus authenticates the consumer by contacting the consumer via the consumer's mobile device to obtain confirmation that the consumer wishes to complete the payment transaction.

8. The apparatus of claim 7, wherein contacting the consumer via the consumer's mobile device further comprises contacting the consumer by one or more of generating a call to the mobile device or generating a message to the mobile device.

9. The apparatus of claim 1, wherein after determining that the payment transaction was initiated using the mobile device, the apparatus authenticates the consumer by:
requesting the user to provide a second form of identification data, the second form of identification data being previously registered for use in authenticating payment transactions initiated using the mobile device;
receiving the second form of identification data from the mobile device; and
verifying that the received second form of identification data is correct.

10. The apparatus of claim 1, wherein the consumer is authenticated without requiring any further authentication process during the payment transaction.

11. A method for authenticating a consumer conducting a payment transaction using a mobile device, comprising:
receiving data identifying the mobile device and data identifying a payment account of the consumer;
authenticating the mobile device using identification data previously supplied by the consumer and associated with the payment account;
receiving data initiating the payment transaction; and
determining that the payment transaction was initiated using the mobile device.

12. The method of claim 11, wherein the payment transaction is processed without requiring the consumer to participate in an authentication process during the transaction.

13. The method of claim 11, wherein the mobile device is a mobile phone and the data identifying the mobile device is a phone number for the mobile phone.

14. The method of claim 11, wherein authenticating the mobile device using identification data previously supplied by the consumer and associated with the payment account further comprises:
requesting the consumer to provide the identification data;
receiving the requested identification data;
verifying the received identification data; and
in response to verifying the identification data, authenticating the mobile device.

15. The method of claim 11, wherein after determining that the payment transaction was initiated using the mobile device, the method further comprises contacting the consumer via the consumer's mobile device to obtain confirmation that the consumer wishes to complete the payment transaction.

16. The apparatus of claim 15, wherein contacting the consumer via the consumer's mobile device further comprises contacting the consumer by one or more of generating a call to the mobile device or generating a message to the mobile device.

17. The method of claim 11, wherein after determining that the payment transaction was initiated using the mobile device, the method further comprises:
requesting the user to provide a second form of identification data, the second form of identification data being previously registered for use in authenticating payment transactions initiated using the mobile device;
receiving the second form of identification data from the mobile device; and
verifying that the received second form of identification data is correct.

18. A method of conducting a payment transaction, comprising:
associating a consumer payment account and first consumer identification data, wherein the first consumer identification data is used by the consumer to approve payment transactions made using the consumer payment account;
receiving data identifying a mobile device and data identifying the consumer payment account;
requesting the consumer to provide the first consumer identification data;
authenticating the mobile device if the response to the request is the first consumer identification data;
receiving data initiating the payment transaction; and
determining that the payment transaction was initiated using the mobile device; and
in response to determining that the payment transaction was initiated using the mobile device, authenticating the consumer.

19. The method of claim 18, further comprising processing the payment transaction without requiring the consumer to participate in an authentication process during the transaction.

20. The method of claim 18, wherein the mobile device is a mobile phone and the data identifying the mobile device is a phone number for the mobile phone.

21. The method of claim 18, wherein requesting the consumer to provide the first consumer identification data further comprises receiving second consumer identification data from the consumer, wherein the second consumer identification data is established for use by the consumer to approve payment transactions made using the mobile device, and authenticating the consumer further comprises receiving the second consumer identification data from the consumer in order to authorize the payment transaction.
